(19) United States
(12) Patent Application Publication
(10) Pub. No.: US 2026/0336004 A1
(43) Pub. Date: Oct. 29, 2026

(54) SOLDER GUN ADAPTOR SYSTEM AND ADAPTATION METHOD

(71) Applicant: Ford Global Technologies, LLC, Dearborn, MI (US)

(72) Inventors: Yongcai Wang, Ann Arbor, MI (US); Chi Paik, Grosse Ile, MI (US); Wenhui Zhu, Northville, MI (US)

(21) Appl. No.: 19/191,012

(22) Filed: Apr. 28, 2025

(51) Int. Cl. B23K 3/08; B23K 3/02; B29C 65/18; B29L 31/36

(52) U.S. Cl. CPC B23K 3/08; B23K 3/026; B29C 65/18; B29L 2031/36

(57) ABSTRACT

A solder gun adaptor system includes an adaptor that is securable to a solder gun. The adaptor receives a heating element of the solder gun when secured to the solder gun. The adaptor receives a tip that is removably securable to the adaptor when the adaptor is secured to the solder gun.

### TECHNICAL FIELD

This disclosure relates generally to adapting a solder gun for heat staking, installing a fastener, or both.

### BACKGROUND

A solder gun is a handheld tool used for melting solder to join components, such as electrical and electronics applications. A solder gun can include a heating element. The solder gun can have barrel-style heating sleeve that holds a solder tip over the heating element. A lock nut can be used to secure the heating sleeve.

### SUMMARY

In some aspects, the techniques described herein relate to a solder gun adaptor system, including: an adaptor that is securable to a solder gun, the adaptor receiving a heating element of the solder gun when secured to the solder gun; and a tip that is removably securable to the adaptor when the adaptor is secured to the solder gun.

In some aspects, the techniques described herein relate to a solder gun adaptor system, wherein the tip threadably engages the adaptor.

In some aspects, the techniques described herein relate to a solder gun adaptor system, wherein the tip includes a threaded bore and the adaptor includes a threaded post, the threaded bore configured to threadably receive the threaded post when the tip is secured to the adaptor.

In some aspects, the techniques described herein relate to a solder gun adaptor system, wherein the adaptor and the tip are threadably securable to each other.

In some aspects, the techniques described herein relate to a solder gun adaptor system, wherein the adaptor includes a threaded post that is received within a threaded bore of the tip when the tip is secured to the adaptor.

In some aspects, the techniques described herein relate to a solder gun adaptor system, wherein the adaptor is secured to the solder gun with a lock nut.

In some aspects, the techniques described herein relate to a solder gun adaptor system, wherein the tip is a heat stake tip.

In some aspects, the techniques described herein relate to a solder gun adaptor system, wherein the heat stake tip is configured to directly contact a polymer-based material to transfer thermal energy from the solder gun to the polymer-based material to melt the polymer-based material.

In some aspects, the techniques described herein relate to a solder gun adaptor system, wherein the heat stake tip includes a cavity that receives the polymer-based material as the polymer-based material melts, the cavity configured to shape the polymer-based material.

In some aspects, the techniques described herein relate to a solder gun adaptor system, wherein the cavity is configured to shape the polymer-based material into a hemispherical shape.

In some aspects, the techniques described herein relate to a solder gun adaptor system, wherein the tip is embedding tip.

In some aspects, the techniques described herein relate to a solder gun adaptor system, wherein the embedding tip includes a post that is configured to be received within a bore of an insert nut.

In some aspects, the techniques described herein relate to a solder gun adaptor system, wherein the embedding tip threadably engages the adaptor when secured to the adaptor.

In some aspects, the techniques described herein relate to a solder gun adaptor system, including: an adaptor configured to receive a heating element of a solder gun through a bore that opens to a first end portion of the adaptor; a heat stake tip that is removably connected to a second end portion of the adaptor when using the solder gun to heat stake a component; and an embedding tip that is removable connected to the second end portion of the adaptor when using the solder gun to anchor an insert nut to a component.

In some aspects, the techniques described herein relate to a solder gun adaptor system, wherein the heat stake tip and the embedding tip are configured to threadably engaged the adaptor.

In some aspects, the techniques described herein relate to a solder gun adaptor system, wherein the heat stake tip and the embedding tip each include a threaded bore that receives a threaded post at the second end portion of the adaptor when connected to the adaptor.

In some aspects, the techniques described herein relate to a solder gun adaptor system, wherein the adaptor is secured to the solder gun with a lock nut.

In some aspects, the techniques described herein relate to a method of adapting a solder gun to secure a polymer-based component, including: securing an adaptor over a heating element of a solder gun; securing a tip to the adaptor; and melting a polymer-based component using the tip.

In some aspects, the techniques described herein relate to a method, wherein the securing of the tip to the adaptor is after the securing of the adaptor over the heating element.

In some aspects, the techniques described herein relate to a method, further including heat staking a busbar to the polymer-based component during the melting.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a sideview of an example electrified vehicle having a traction battery pack.

FIG. 2 illustrates a perspective view of a portion of a busbar assembly from the traction battery pack of FIG. 1.

FIG. 3 illustrates a section view taken at line 3-3 in FIG. 2 prior to heat staking a busbar of the busbar assembly to a frame of the busbar assembly.

FIG. 4 illustrates the section view taking at line 3-3 in FIG. 2 after heat staking.

FIG. 5 illustrates an example solder gun with selected components duplicated and expanded.

FIG. 6 illustrates a solder gun adaptor system for use with the solder gun of FIG. 5 according to an exemplary aspect of the present disclosure.

FIG. 7 illustrates a perspective view of the solder gun of FIG. 5 after being adapted by the solder gun adaptor system of FIG. 6 into a heat staking configuration.

FIG. 8 illustrates a section view of a portion of the solder gun of FIG. 7 when heat staking a component.

FIG. 9 illustrates, in a section view, the portion of the solder gun of FIG. 8 after the solder gun has been adapted by the solder gun adaptor system of FIG. 6 into a fastener anchoring configuration.

### DETAILED DESCRIPTION

This disclosure details a system that can adapt a solder gun for heat staking or for anchoring a fastener, such as an insert nut.

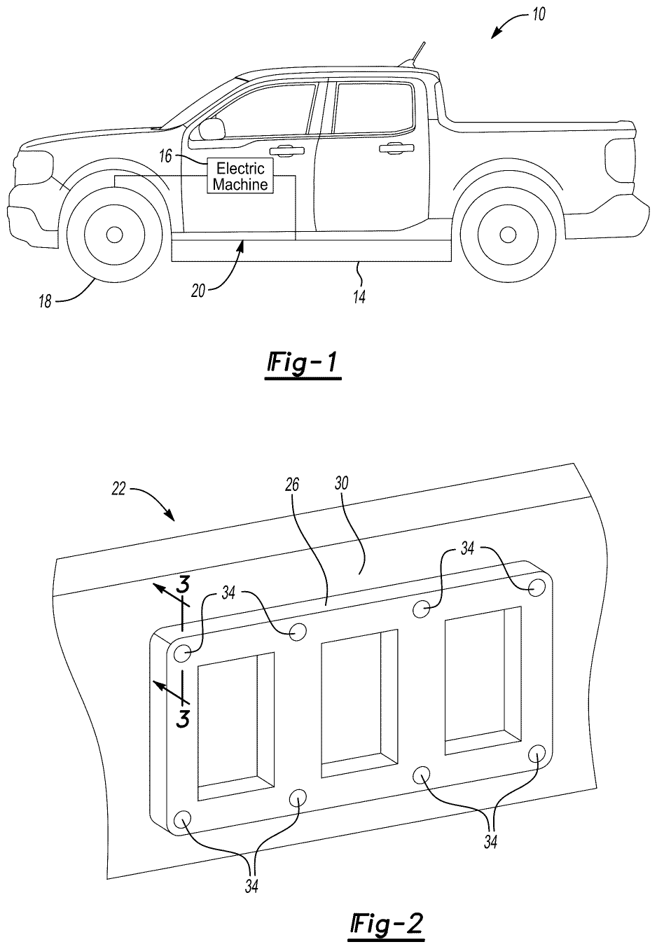

With reference to FIG. 1, an electrified vehicle 10 includes a traction battery pack 14, an electric machine 16, and wheels 18. The traction battery pack 14 powers the electric machine 16, which can convert electrical power to mechanical power to drive the wheels 18. The traction battery pack 14 can be a relatively high-voltage battery.

The traction battery pack 14 is, in the exemplary embodiment, secured to an underbody 20 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference to FIG. 2, the traction battery pack 14 and other areas of the electrified vehicle 10 can include various components that are secured to each other. In the example of FIG. 2, a busbar assembly 22 includes a plurality of busbars 26 secured to a frame 30, which is a polymer-based material. A plurality of heat stakes 34 are used to secure the busbars 26 to the frame 30.

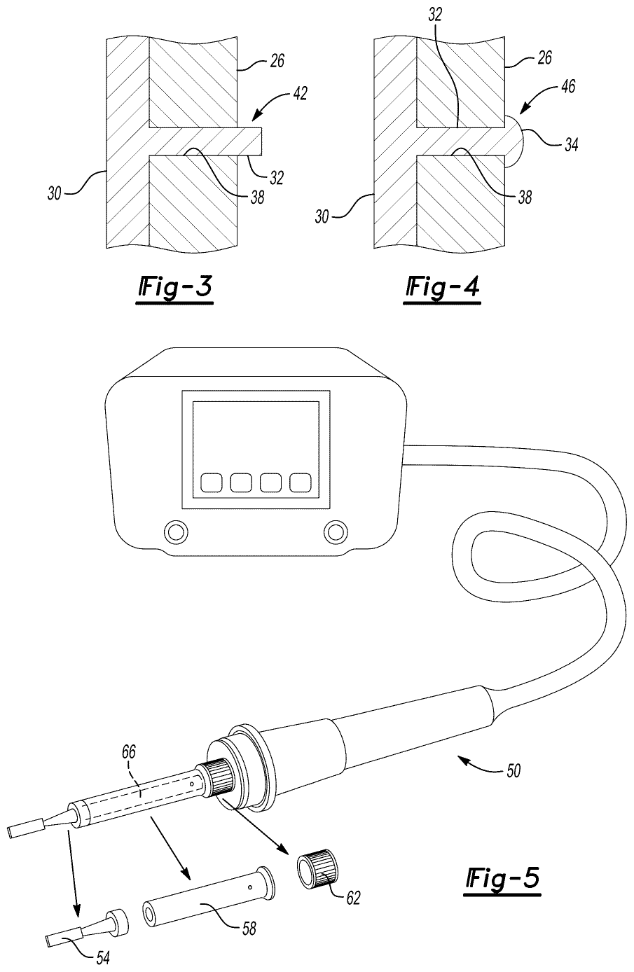

With reference to FIG. 3, in the exemplary embodiment, securing the busbar 26 to the frame 30 involves first placing the busbar 26 over a post 32 of the frame 30. The post 32 extends through an aperture 38 in the busbar 26 and is long enough such that an end portion 42 of the post 32 projects from the busbar 26. The end portion 42 provides material to create a mushroom-shaped dome of a heat stake.

During heat staking, the end portion 42 is heated until the end portion 42 melts or softens and can be reshaped into an enlarged head 46 as shown in FIG. 4. After the enlarged head 46 cures and hardens, the busbar 26 is held in place by the enlarged head 46.

Heat stakes, as would be understood by a person having skill in this art, can be used to securing a first component that is polymer-based to a second component. Heat staking can be used to secure together parts having dissimilar material without the use of separate mechanical fasteners. Appearance and connective strength of the heat stake can be influenced by the tools utilized to form the heat stake.

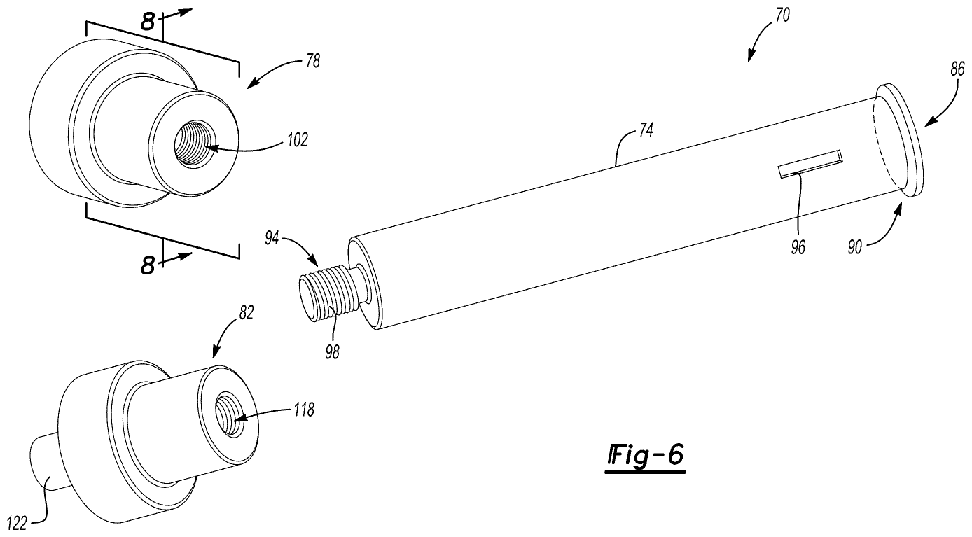

With reference now to FIG. 5, in the exemplary embodiment, a solder gun 50 includes a soldering tip 54, a heating sleeve 58, a lock nut 62, and a heating element 66. The solder gun 50 is a hand-held tool used for melting solder to join metal components, typically in electrical and electronics work. The solder gun 50, when used for soldering, is assembled as shown in FIG. 5 with the lock nut 62 securing the soldering tip 54 and heating sleeve 58 over the heating element 66.

With reference now to FIGS. 6-8 and continuing reference to FIG. 5, an adaptor system 70 can be used to reconfigure the solder gun 50. The example adaptor system 70 includes a barrel adaptor sleeve 74, a first tip 78, and a second tip 82. The first tip 78 and the second tip 82 are selectively securable to the barrel adaptor sleeve 74.

The example barrel adaptor sleeve 74 has a bore 86 opening to a first end 90. An opposite, second end 94 of the barrel adaptor sleeve 74 is configured to removably connect to the first tip 78 or the second tip 82. The barrel adaptor sleeve 74 includes one or more slots 96 to provide a path for heated air to release through the barrel adaptor sleeve 74.

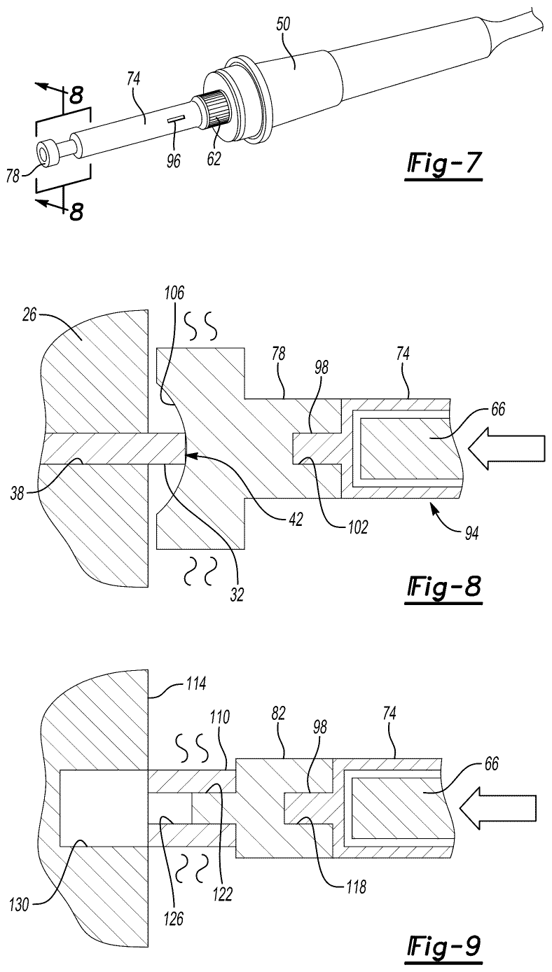

When the solder gun 50 is adapted by the adaptor system 70 for heat staking as shown in FIG. 7, the adaptor system 70 can be used with the first tip 78 secured to the barrel adaptor sleeve 74. The first tip 78 can be consider a heat stake tip.

To adapt the solder gun 50 for heat staking, the lock nut 62 is unscrewed. The heating sleeve 58 and the soldering tip 54 are then removed to expose the heating element 66. The barrel adaptor sleeve 74 is then positioned over the heating element 66 by inserting the heating element 66 into the bore 86. The barrel adaptor sleeve 74 is secured over the heating element 66 utilizing the lock nut 62.

The first tip 78 is then removably secured to the second end 94 of the barrel adaptor sleeve 74. In the exemplary embodiment, the second end 94 of the barrel adaptor sleeve 74 includes a threaded post 98 that is threadably engaged within a corresponding bore 102 provided by the first tip 78. In other examples, the barrel adaptor sleeve 74 could include the bore 102 that receives a threaded post provided by the first tip 78.

In this example, the first tip 78 is secured to the barrel adaptor sleeve 74 after the lock nut 62 is used to secure the barrel adaptor sleeve 74 over the heating element 66. In other examples, the first tip 78 could be secured to the barrel adaptor sleeve 74 and the barrel adaptor sleeve 74 then positioned over the heating element 66.

With the first tip 78 secured to the barrel adaptor sleeve 74, and the barrel adaptor sleeve 74 secured to the solder gun 50 utilizing the lock nut 62, the solder gun 50 can be utilized to heat stake a first component to a second component.

A user can activate the heating element 66 of the solder gun 50 while pressing the first tip 78 against the post 32. Activating the heating element 66 heats the first tip 78. The example first tip 78 includes a hemispherical or dome-shaped cavity 106 that can receive the end portion 42 of the post 32 when pressing the first tip 78 against the end portion 42 of the post 32. When pressing the first tip 78 against the end portion 42, the first tip 78 directly contacts the first tip 78.

During the pressing, thermal energy transfers to the end portion 42 of the post 32 causing it to melt or soften. The cavity 106 shapes the melted or softened material into the enlarged head 46 (FIG. 4) having the hemispherical shape. After forming the enlarged head 46, the solder gun 50 and the first tip 78 can be withdrawn from the end portion 42, which then cures to provide the enlarged head 46 that captures the busbar 26 against the frame 30.

Instead of heat staking, the adaptor system 70 can be adapted to embed a fastener, such as an insert nut, within a polymer-based component. To embed a fastener, the adaptor system 70 utilizes the second tip 82 instead of the first tip 78. Embedding the fastener with the solder gun 50 and the adaptor system 70 can involve heating the fastener and then pressing the heated fastener into a polymer-based material. The second tip 78 can be considered an embedding tip.

FIG. 9 shows the adaptor system 70 being utilized to embed a fastener, here an insert nut 110, within a polymer-based component 114. Once embedded, the insert nut 110 can be used to anchor various components to the polymer-based component 114. For example, the insert nut 110 can provide a threaded bore that a mechanical fastener engages to anchor a component, such as a circuit board, to the polymer-based component 114.

To reconfigure the adaptor system 70 and the solder gun 50 for embedding the insert nut 110, the first tip 78 is removed from the barrel adaptor sleeve 74 and the second tip 82 is secured to the barrel adaptor sleeve 74. The first tip 78, if secured to the barrel adaptor sleeve 74, can be removed to expose the threaded post 98. The second tip 82 can then be removably secured to the barrel adaptor sleeve 74 by engaging a threaded bore 118 of the second tip 82 with the threaded post 98. The second tip 82, like the first tip 78, threadably receives the threaded post 98 when the second tip 82 is secured to the barrel adaptor sleeve 74.

The second tip 82, in this example, is an insert nut carrying tip. In particular, the example second tip 82 includes a post 122 configured to be received within a bore 126 of the insert nut 110 to carry the insert nut 110.

During installation, the insert nut 110 can be mounted on the second tip 82 by placing the post 122 of the second tip 82 within the bore 126 of the insert nut 110. The heating element 66 of the solder gun 50 can then be activated, which heats the second tip 82 and the insert nut 110 carried on the post 122 of the second tip 82.

The insert nut 110 when sufficiently heated can then be pressed into an aperture 130 provided within the polymer-based component 114. A diameter of the aperture 130 is a bit smaller than a diameter of the insert nut 110. The material of the polymer-based component 114 melts due to the thermal energy to permit embedding of the insert nut 110 into the aperture 126 of the polymer-based component 114. After being inserted to a desired depth, the post 122 can be withdrawn from the bore 130 of the insert nut 110 leaving the insert nut 110 embedded within the polymer-based material 114, which then cures to hold a position of the insert nut 110. An outer diameter of the insert nut 110 can include helix teeth to help the insert nut 110 grip the polymer-based component 114.

Features of the disclosed examples include adapting an off-the-shelf solder gun to be utilized for securing techniques that are separate and distinct from melting solder. The solder gun, with the example adaptor system of this disclosure can be selectively used for heat staking or embedding an insert nut in an installed position.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A solder gun adaptor system, comprising:
an adaptor that is securable to a solder gun, the adaptor receiving a heating element of the solder gun when secured to the solder gun; and
a tip that is removably securable to the adaptor when the adaptor is secured to the solder gun.

2. The solder gun adaptor system of claim 1, wherein the tip threadably engages the adaptor.

3. The solder gun adaptor system of claim 1, wherein the tip includes a threaded bore and the adaptor includes a threaded post, the threaded bore configured to threadably receive the threaded post when the tip is secured to the adaptor.

4. The solder gun adaptor system of claim 1, wherein the adaptor and the tip are threadably securable to each other.

5. The solder gun adaptor system of claim 4, wherein the adaptor includes a threaded post that is received within a threaded bore of the tip when the tip is secured to the adaptor.

6. The solder gun adaptor system of claim 1, wherein the adaptor is secured to the solder gun with a lock nut.

7. The solder gun adaptor system of claim 1, wherein the tip is a heat stake tip.

8. The solder gun adaptor system of claim 7, wherein the heat stake tip is configured to directly contact a polymer-based material to transfer thermal energy from the solder gun to the polymer-based material to melt the polymer-based material.

9. The solder gun adaptor system of claim 8, wherein the heat stake tip includes a cavity that receives the polymer-based material as the polymer-based material melts, the cavity configured to shape the polymer-based material.

10. The solder gun adaptor system of claim 9, wherein the cavity is configured to shape the polymer-based material into a hemispherical shape.

11. The solder gun adaptor system of claim 1, wherein the tip is embedding tip.

12. The solder gun adaptor system of claim 11, wherein the embedding tip includes a post that is configured to be received within a bore of an insert nut.

13. The solder gun adaptor system of claim 12, wherein the embedding tip threadably engages the adaptor when secured to the adaptor.

14. A solder gun adaptor system, comprising:
an adaptor configured to receive a heating element of a solder gun through a bore that opens to a first end portion of the adaptor;
a heat stake tip that is removably connected to a second end portion of the adaptor when using the solder gun to heat stake a component; and
an embedding tip that is removable connected to the second end portion of the adaptor when using the solder gun to anchor an insert nut to a component.

15. The solder gun adaptor system of claim 14, wherein the heat stake tip and the embedding tip are configured to threadably engaged the adaptor.

16. The solder gun adaptor system of claim 15, wherein the heat stake tip and the embedding tip each include a threaded bore that receives a threaded post at the second end portion of the adaptor when connected to the adaptor.

17. The solder gun adaptor system of claim 16, wherein the adaptor is secured to the solder gun with a lock nut.

18. A method of adapting a solder gun to secure a polymer-based component, comprising:
securing an adaptor over a heating element of a solder gun;
securing a tip to the adaptor; and
melting a polymer-based component using the tip.

19. The method of claim 18, wherein the securing of the tip to the adaptor is after the securing of the adaptor over the heating element.

20. The method of claim 18, further comprising heat staking a busbar to the polymer-based component during the melting.
